(19) United States
(12) Patent Application Publication
(10) Pub. No.: US 2019/0370651 A1
(43) Pub. Date: Dec. 5, 2019

(54) Deep Co-Clustering

(71) Applicant: NEC Laboratories America, Inc., Princeton, NJ (US)

(72) Inventors: Wei Cheng, Princeton Junction, NJ (US); Haifeng Chen, West Windsor, NJ (US); Jingchao Ni, Princeton, NJ (US)

(21) Appl. No.: 16/429,425

(22) Filed: Jun. 3, 2019

Related U.S. Application Data
(60) Provisional application No. 62/679,749, filed on Jun. 1, 2018.

(51) Int. Cl. G06N 3/08; G06F 16/28; G06N 5/04

(52) U.S. Cl. CPC G06N 3/08; G06N 5/04; G06F 16/285

(57) ABSTRACT

Methods and systems for co-clustering data include reducing dimensionality for instances and features of an input dataset independently of one another. A mutual information loss is determined for the instances and the features independently of one another. The instances and the features are cross-correlated, based on the mutual information loss, to determine a cross-correlation loss. Co-clusters in the input data are determined based on the cross-correlation loss.

### RELATED APPLICATION INFORMATION

This application claims priority to U.S. Provisional Patent Application No. 62/679,749, filed on Jun. 1, 2018, incorporated herein by reference herein its entirety.

### BACKGROUND

### Technical Field

The present invention relates to co-clustering data and, more particularly, to co-clustering that uses neural networks.

### Description of the Related Art

Co-clustering clusters both instances and features simultaneously. For example, when rating movies, people and their rating values can be considered as instances and features, respectively. Seen another way, data expressed in the rows and columns of a matrix can represent respective instances and features. The duality between instances and features indicates that instances can be grouped based on features, and that features can be grouped based on instances.

### SUMMARY

A method for co-clustering data includes reducing dimensionality for instances and features of an input dataset independently of one another. A mutual information loss is determined for the instances and the features independently of one another. The instances and the features are cross-correlated, based on the mutual information loss, to determine a cross-correlation loss. Co-clusters in the input data are determined based on the cross-correlation loss.

A data co-clustering system includes an instance autoencoder configured to reduce a dimensionality for instances of an input dataset. A feature autoencoder is configured to reduce a dimensionality for features of an input dataset. An instance mutual information loss branch is configured to determining a mutual information loss for the instances. A feature mutual information loss branch is configured to determine a mutual information loss for the features. A processor is configured to cross-correlate the instances and the features based on the mutual information loss, to determine a cross-correlation loss and to determine co-clusters in the input data based on the cross-correlation loss.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a method/system for co-clustering data in accordance with an embodiment of the present invention;

FIG. 2 is a diagram of an exemplary neural network in accordance with an embodiment of the present invention;

FIG. 3 is a block/flow diagram of a method for classifying documents based on co-clustering in accordance with an embodiment of the present invention;

FIG. 4 is a block diagram of a data co-clustering system in accordance with an embodiment of the present invention; and

FIG. 5 is a block diagram of a processing system in accordance with an embodiment of the present invention.

### DETAILED DESCRIPTION OF PREFERRED EMBODIMENTS

In accordance with the present invention, systems and methods are provided that perform co-clustering using deep neural networks. The present embodiments use a deep autoencoder to generate low-dimensional representations for instances and features, which are then used as input to respective inference paths, each including an inference network and a Gaussian mixture model (GMM). The GMM outputs are cross-correlated using mutual information loss. The present embodiments can optimize the parameters of the deep-autoencoder, the inference neural network, and the GMM jointly.

Co-clustering, as described herein, is particularly advantageous for its identification of feature clusters based on instance clusters. One exemplary application for co-clustering is in text document classification, particularly when training labels are not used. Co-clustering identifies word clusters for each document cluster, making it easy to know the category of each document cluster from the words in the corresponding word cluster. Thus, once the major words in a document have been identified, co-clustering makes it possible to identify the category that a new document belongs to.

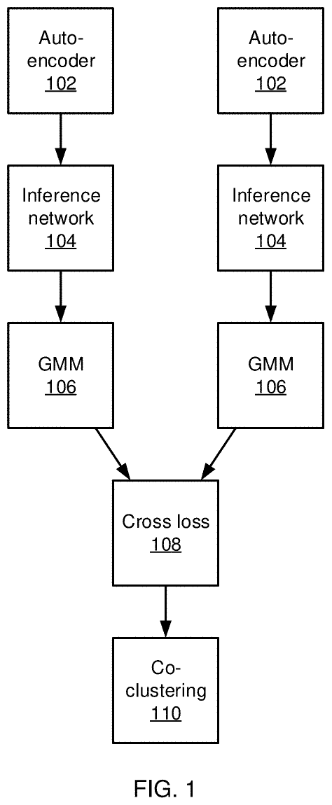

Referring now to FIG. 1, a block diagram is shown that illustrates the steps performed by the present embodiments. The instances and features are provided to separate paths. The duality between instances and features indicates that instances can be grouped based on features and that features can be grouped based on instances.

In each path, the raw input is provided to a deep autoencoder 102 that reduces the dimensionality of the input. The deep autoencoder 102 performs an encoding from the original high-dimensional space to a low-dimensional space. The deep autoencoder 102 then decodes the low-dimensional encoding to reproduce the high-dimensional input to verify that the low-dimensional encoding maintains the information of the original input data. The encoded instances and features are then output by their respective autoencoders 102.

An inference network 104 and a GMM 106 provides cluster assignments for the instances and the features, providing a mutual information loss. Cross-correlation block 108 uses the mutual information loss to correlate the instances with the features, providing the co-clustered output.

To use one example, text document data can represent the documents as instances and the words within the documents as features Similar documents usually share similar word distributions, so that the instances of text document data can be grouped into clusters based on the features, while similar words often exist in similar documents. The features can then be clustered based on the instances.

In some embodiments, the instances and features can be represented as a data matrix. After clustering, the instances and features can be reorganized into homogeneous blocks referred to herein as co-clusters. Co-clusters are subsets of an original data matrix and are characterized as a set of instances and a set of features, with values in a given subset being similar. Co-clusters reflect the structural information in the original data and can indicate relationships between instances and features. Besides identifying similar documents, the present embodiments can be of particular use in fields relating to bioinformatics, recommendation systems, and image segmentation. Co-clustering is superior to traditional clustering in these fields because of its ability to use the relationships between instances and features.

In the present embodiments, the instances are represented as {xᵢ}ᵢ₌₁ⁿ={x₁, . . . , xₙ} and the features are represented as {yᵢ}ⱼ₌₁^{d}={y₁, . . . , y_{d}}, with n being a number of instances and d being a number of features. These instances and features are clustered into g instance clusters and g feature clusters. Co-clustering in the present embodiments therefore finds maps Cᵣ and C_{c}:

Cᵣ:{x₁, . . . ,xₙ}→{\hat{x}₁, . . . ,\hat{x}_{g}}

C_{c}:{y₁, . . . ,y_{d}}→{ŷ₁, . . . ,ŷₘ}

where r and c designate rows (instances) and columns (features). The instances can be reordered such that instances that are grouped into the same cluster are arranged to be adjacent. Similar arrangements can be applied to features.

The new data structure includes blocks of similar instances and features, referred to herein as co-clusters. If X and Y are two discrete, random variables taking values from the sets {xᵢ}ᵢ₌₁ⁿ and {yᵢ}ⱼ₌₁^{d} separately, then the joint probability distribution between X and Y is denoted herein as p(X, Y). Similarly, if \hat{X} and Ŷ are two discrete random variables from the sets {\hat{x}ᵢ}ₛ₌₁^{g} and {ŷᵢ}ₜ₌₁^{m}, where {\hat{x}ᵢ}ₛ₌₁^{g}={\hat{x}₁, . . . ,\hat{x}_{g}} and {ŷᵢ}ₜ₌₁^{m}={ŷ₁, . . . ,ŷₘ}, the joint probability distribution between \hat{X} and Ŷ is denoted as p(\hat{X},Ŷ). \hat{X} and Ŷ indicate the partitions induced by X and Y−\hat{X}=Cᵣ(X) and Ŷ=C_{c}(Y).

As described above, the first step in performing co-clustering is to reduce the dimension of input data in block 102. Some embodiments of the present invention use deep stacked autoencoders that perform unsupervised representation learning. The autoencoders 102 reduce both instances and features separately. Given the i^{th} instance and the i^{th} feature as xᵢ and yⱼ, the lower-dimension representations are denoted herein as:

zᵢ=fᵣ(xᵢ;θᵣ)

wⱼ=f_{c}(yⱼ;θ_{c})

where fᵣ and f_{c} denote encoding functions for instances and features, respectively, and θᵣ and θ_{c} denote parameters of the autoencoders 102. The encoding functions can be linear or nonlinear, depending on the domain data. The reconstruction losses of xᵢ and yⱼ are denoted as l(xᵢ, gᵣ(zᵢ; θᵣ)) and l(yⱼ, g_{c}(wⱼ;θ_{c})) separately, where gᵣ and g_{c} are decoding functions for instances and features, respectively.

Using the low-dimensional representations produced by the autoencoders 102, the present embodiments use variational inference to produce clustering assignment probabilities. Deep neural networks are used as the inference neural networks 104, using the low-dimensional representations as inputs. The outputs of the inference networks 104 are new representations of instances xᵢ and yⱼ, denoted as:

hᵢ=hᵢ₁, . . . ,h_{ig})^{T}

vⱼ=(vⱼ₁, . . . ,vⱼₘ)^{T}

where g and m are the cluster numbers of instances and features, respectively. These representations can also be considered as clustering assignment probabilities when a softmax function is deployed as the last layer of the inference network.

These outputs are also generated by GMM blocks 106. The posterior clustering assignment probability distributions of hᵢ and vⱼ, based on GMM, are denoted as P_{ϕ}_{ᵣ}(k|hᵢ) and P_{ϕ}_{_{c}}(k|vⱼ), where ϕᵣ and ϕ_{c} are the parameters of GMM when dealing with instances and features separately. The clustering assignment distributions of instances and features, based on the inference neural network 104, are denoted as Q_{η}_{ᵣ}(k|hᵢ) and Q_{η}_{ᵣ}(k|hⱼ), where ηᵣ and η_{c} denote the parameters of the inference networks 104.

Instead of applying a two-step strategy for GMM, the present embodiments jointly train the inference neural network 104 and GMM 106 in an end-to-end fashion. Similar training can be performed for both instances and features. Given the output of the autoencoders 102, new representations based on the inference neural network 104 can be expressed as:

hᵢ=softmax(Inf(zᵢ;ηᵣ)

where Inf indicates the inference neural network 104. The mixture probability, mean, and covariance of the k^{th} component in the GMM (ϕᵣ={πᵣ^{k},μᵣ^{k},Σᵣ^{k}) for instances can be estimated as:

$${π}_{r}^{k} = {N}_{r}^{k} / {N}_{r}$$

$${μ}_{r}^{k} = \frac{1}{{N}_{r}^{k}} {\sum }_{i = 1}^{{N}_{r}^{k}} {h}_{ik } {h}_{i}$$

$${Σ}_{r}^{k} = \frac{1}{{N}_{r}^{k}} {\sum }_{i = 1}^{{N}_{r}} {h}_{ik} ( {h}_{i} - {μ}_{r}^{k} ) {( {h}_{i} - {μ}_{r}^{k} )}^{T}$$

where Nᵣ=n is the number of instances, Nᵣ^{k}=Σᵢ₌₁^{N}^{ᵣ}hᵢₖ, and hᵢₖ is the value on the k^{th} dimensionality of hᵢ. If πᵣ^{k}, μᵣ^{k}, and Σᵣ^{k} are given, the clustering probability of i^{th} instance belonging to the k^{th} cluster is:

$${γ}_{r ( i )}^{k} = \frac{{π}_{r}^{k} 𝒩 ( {h}_{i} \vert {μ}_{r}^{k} , {Σ}_{r}^{k} )}{{\sum }_{{k}^{′} = 1}^{g} {π}_{r}^{{k}^{′}} 𝒩 ( {h}_{i} \vert {μ}_{R}^{{k}^{′}} , {Σ}_{r}^{{k}^{′}} )}$$

where [symbol] (•) is the normal distribution probability density function. The log-likelihood can then be written as:

$$log \{ {\prod }_{i = 1}^{{N}_{r}} {P}_{{φ}_{r}} ( {h}_{i} ) \} = {\sum }_{i = 1}^{{N}_{r}} log {P}_{{φ}_{r}} ( {h}_{i} ) = {\sum }_{i = 1}^{{N}_{r}} log \{ {\sum }_{k = 1}^{K} {π}_{r}^{k} 𝒩 ( {h}_{i} \vert {μ}_{r}^{k} , {Σ}_{r}^{k} ) \}$$

Instead of maximizing the log-likelihood function directly, the present embodiments maximize the variational lower bound on the log-likelihood. The benefits are two-fold, making the distribution Q_{η}_{ᵣ} a better approximation to the distribution P_{ϕ}_{ᵣ} by minimizing the KL divergence between them, and tightening the bound of the log-likelihood function to make the training process more effective. The variational lower bound on log-likelihood, [symbol] ᵣ is defined as:

$${\sum }_{i = 1}^{{N}_{r}} \{ {E}_{Q} [ log ( P ( k \vert {h}_{i} ) ) ] + H ( k \vert {h}_{i} ) \}$$

where H(k|hᵢ)=−E_{Q}(log(Q(k|hᵢ))) is the Shannon entropy and P_{ϕ}_{ᵣ} and Q_{η}_{ᵣ} are represented as P and Q for brevity.

The clustering assignment probability for the j^{th} feature belonging to the k^{th} cluster is expressed as:

$${γ}_{c ( j )}^{k} = \frac{{π}_{c}^{k} 𝒩 ( {v}_{j} \vert {μ}_{c}^{k} , {Σ}_{c}^{k} )}{{\sum }_{{k}^{′} = 1}^{m} {π}_{c}^{{k}^{′}} 𝒩 ( {v}_{j} \vert {μ}_{c}^{{k}^{′}} , {Σ}_{c}^{{k}^{′}} )}$$

where π_{c}^{k}, μ_{c}^{k}, and Σ_{c}^{k} are the mixture probability, mean, and covariance of the k^{th} component in the GMM for the features, and m is the number of feature clusters. The variational lower bound on log-likelihood for features is:

$${ℒ}_{c} = {\sum }_{j = 1}^{{N}_{c}} \{ {E}_{Q} [ log ( P ( k , {v}_{j} ) ) ] - {E}_{Q} ( log ( Q ( k \vert {v}_{j} ) ) )$$

where N_{c}=d is the number of features, and P_{ϕ}_{_{c}} and Q_{η}_{_{c}} are denoted as P and Q for brevity. Finally, the present embodiments take − [symbol] ᵣ and − [symbol] _{c} as the losses for clustering assignment of instances and features.

The cross-loss block 108 uses mutual information to correlate the trainings of instances and features. Based on the clustering assignments, the present embodiments construct a joint probability distribution between instances and features as p(X, Y) and the joint probability distribution between instance clusters and feature clusters as p(\hat{X}, Ŷ). Block 108 penalizes the mutual information loss be-tween the two joint probability distributions.

Given the clustering assignment probability of the i^{th} instance as γᵣ₍ᵢ₎=(γᵣ₍ᵢ₎¹, . . . ,γᵣ₍ᵢ₎^{g})^{T} and the j^{th} feature as γ_{c(j)}=(γ_{c(j)}¹, . . . ,γ_{c(j)}^{g})^{T}, the joint probability between the i^{th} instance and the j^{th} feature is denoted as p(xᵢ,yⱼ)= [symbol] (γᵣ₍ᵢ₎,γ_{c(j)}), where [symbol] (•) is a function to calculate the joint probability, such as the dot product. The joint probability between the s^{th} instance cluster, \hat{x}ₛ, and the t^{th} feature cluster, ŷₜ, is calculated as:

p(\hat{x}ₛ,ŷₜ)=Σ{p(xᵢ,yⱼ)|xᵢ∈\hat{x}ₛ,yⱼ∈ŷₜ}

The dot product can be used for [symbol] (•) because many use cases have equal numbers of instances and features and because there is a corresponding relationship between instance clusters and feature clusters, where similar instances share similar features. Although the dot product is specifically contemplated, the function can be any appropriate function according to the needs of the application.

Given the joint probability distributions p(X, Y) and p(\hat{X}, Ŷ), the mutual information between X and Y and between \hat{X} and Ŷ are calculated as:

$$I ( X ; Y ) = {\sum }_{{x}_{i}} {\sum }_{{y}_{j}} p ( {x}_{i} , {y}_{j} ) log ( \frac{p ( {x}_{i} , {y}_{j} )}{p ( {x}_{i} ) p ( {y}_{j} )} \\ I ( \hat{X} ; \hat{Y} ) = {\sum }_{{\hat{x}}_{s}} {\sum }_{{\hat{y}}_{t}} p ( {\hat{x}}_{s} , {\hat{y}}_{t} ) log ( \frac{p ( {\hat{x}}_{s} , {\hat{y}}_{t} )}{p ( {\hat{x}}_{s} ) p ( {\hat{y}}_{t} )}$$

where p(xᵢ)=Σ_{y}_{ⱼ}p(xᵢ,yⱼ), p(yⱼ)=Σₓ_{ᵢ}p(xᵢ,yⱼ), p(\hat{x}ₛ)=Σ_{ŷ}_{ₜ}p(\hat{x}ₛ,ŷₜ), and p(ŷₜ)=Σ_{\hat{x}}_{ₛ}p(\hat{x}ₛ,ŷₜ) The difference between I(X; Y)−I(\hat{X}; Ŷ) is:

KL(p(X;Y)∥q(X,Y))

where KL(•) is the Kullback-Liebler divergence and

$$q ( {x}_{i} , {y}_{j} ) = p ( {\hat{x}}_{s} , {\hat{y}}_{t} ) ( \frac{p ( {x}_{i} )}{p ( {\hat{x}}_{s} )} ) ( \frac{p ( {y}_{j} )}{p ( {\hat{y}}_{t} )} ) .$$

The difference is greater than equal to zero, and each joint probability distribution is also greater than equal to zero, leaving the instance-feature cross loss as:

$$1 - \frac{I ( \hat{X} ; \hat{Y} )}{I ( X ; Y )}$$

The cross loss term shows that the difference between the joint probability distributions should not be significant for an optimal co-clustering.

Co-clustering is then performed in block 110 using the cross loss. Co-clustering optimizes an objective function,

$${min}_{{θ}_{r} , {θ}_{c} , {η}_{r} , {η}_{c}} J = {J}_{1} + {J}_{2} + {J}_{3} ,$$

to tend the parameters θᵣ, θ_{c}, ηᵣ, η_{c}, where J₁ and J₂ are the losses for the trainings of instances and feature, respectively, J₃ is the instance-feature cross loss, θᵣ and θ_{c} are the parameters of the autoencoders 102, and ηᵣ and η_{c} are the parameters of the inference neural networks 104. The parts of the objective function are broken down as follows:

$${J}_{1} = \frac{1}{n} {\sum }_{i = 1}^{n} l ( {x}_{i} , {g}_{r} ( {z}_{i} ) ) + {λ}_{1} {P}_{ae} ( {θ}_{r} ) + {λ}_{2} ( - {ℒ}_{r} ) + {λ}_{e} {P}_{inf} ( {Σ}_{r} )$$

$${J}_{2} = \frac{{λ}_{4}}{d} {\sum }_{j = 1}^{d} l ( {y}_{j} , {g}_{c} ( {w}_{j} ) ) + {λ}_{5} {P}_{ae} ( {θ}_{c} ) + {λ}_{6} ( - {ℒ}_{c} ) + {λ}_{7} {P}_{inf} ( {Σ}_{c} )$$

$${J}_{3} = {λ}_{8} ( 1 - \frac{I ( \hat{X} ; \hat{Y} )}{I ( X ; Y )} )$$

where l(xᵢ, gᵣ (zᵢ)) and l(yⱼ, g_{c}(wⱼ)) are reconstruction losses for the autoencoders 102, Pₐₑ(θᵣ) and Pₐₑ (θᵣ) are the penalties for the parameters of the autoencoders 102, the λ factors are parameters used to balance different parts of the loss function, and [symbol] ᵣ and [symbol] _{c} are the variational lower bounds. The A parameters are optimized by cross-validation. The terms P_{inf}(Σᵣ) and Pᵢₙₜ(Σ_{c}) are the sum of the inverse of the diagonal entries of covariance matrices:

$${P}_{inf} ( {Σ}_{r} ) = {\sum }_{k = 1}^{g} {\sum }_{i = 1}^{{d}_{r}} \frac{1}{{Σ}_{{r}_{ii}}^{k}}$$

$${P}_{inf} ( {Σ}_{c} ) = {\sum }_{k = 1}^{m} {\sum }_{j = 1}^{{d}_{c}} \frac{1}{{Σ}_{{c}_{jj}}^{k}}$$

where dᵣ and d_{c} are the data dimensionality of the outputs of the autoencoders 102. The P_{inf} terms are used to avoid trivial solutions where diagonal entries in covariance matrices degenerate to zero. The output of the optimization is the clustering assignments of both samples and features.

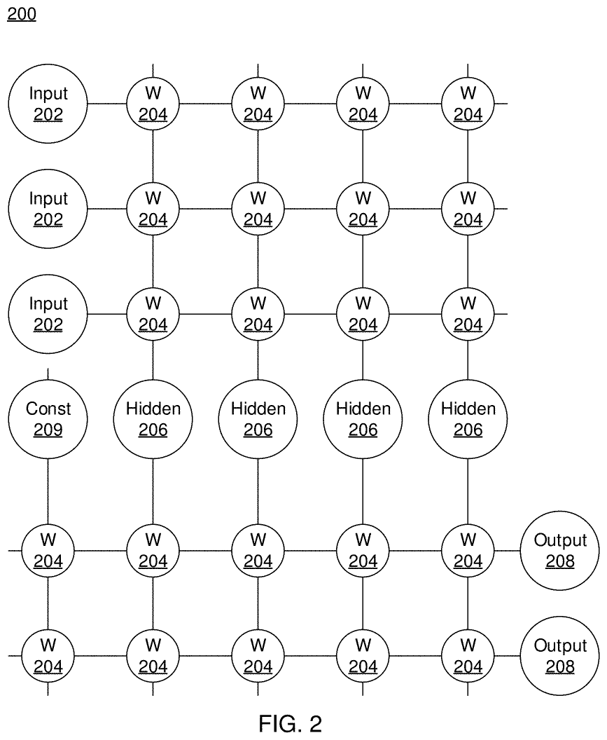

Referring now to FIG. 2, an artificial neural network (ANN) architecture 200 is shown. It should be understood that the present architecture is purely exemplary and that other architectures or types of neural network may be used instead. In the context of the present embodiments, it should be understood that additional layers will be used for the autoencoders 102, inference networks 104, and GMM networks 106. The ANN embodiment described herein is included with the intent of illustrating general principles of neural network computation at a high level of generality and should not be construed as limiting in any way.

Furthermore, the layers of neurons described below and the weights connecting them are described in a general manner and can be replaced by any type of neural network layers with any appropriate degree or type of interconnectivity. For example, layers can include convolutional layers, pooling layers, fully connected layers, softmax layers, or any other appropriate type of neural network layer. Furthermore, layers can be added or removed as needed and the weights can be omitted for more complicated forms of interconnection.

During feed-forward operation, a set of input neurons 202 each provide an input signal in parallel to a respective row of weights 204. In the hardware embodiment described herein, the weights 204 each have a respective settable value, such that a weight output passes from the weight 204 to a respective hidden neuron 206 to represent the weighted input to the hidden neuron 206. In software embodiments, the weights 204 may simply be represented as coefficient values that are multiplied against the relevant signals. The signals from each weight adds column-wise and flows to a hidden neuron 206.

The hidden neurons 206 use the signals from the array of weights 204 to perform some calculation. The hidden neurons 206 then output a signal of their own to another array of weights 204. This array performs in the same way, with a column of weights 204 receiving a signal from their respective hidden neuron 206 to produce a weighted signal output that adds row-wise and is provided to the output neuron 208.

It should be understood that any number of these stages may be implemented, by interposing additional layers of arrays and hidden neurons 206. It should also be noted that some neurons may be constant neurons 209, which provide a constant output to the array. The constant neurons 209 can be present among the input neurons 202 and/or hidden neurons 206 and are only used during feed-forward operation.

During back propagation, the output neurons 208 provide a signal back across the array of weights 204. The output layer compares the generated network response to training data and computes an error. The error signal can be made proportional to the error value. In this example, a row of weights 204 receives a signal from a respective output neuron 208 in parallel and produces an output which adds column-wise to provide an input to hidden neurons 206. The hidden neurons 206 combine the weighted feedback signal with a derivative of its feed-forward calculation and stores an error value before outputting a feedback signal to its respective column of weights 204. This back propagation travels through the entire network 200 until all hidden neurons 206 and the input neurons 202 have stored an error value.

During weight updates, the stored error values are used to update the settable values of the weights 204. In this manner the weights 204 can be trained to adapt the neural network 200 to errors in its processing. It should be noted that the three modes of operation, feed forward, back propagation, and weight update, do not overlap with one another.

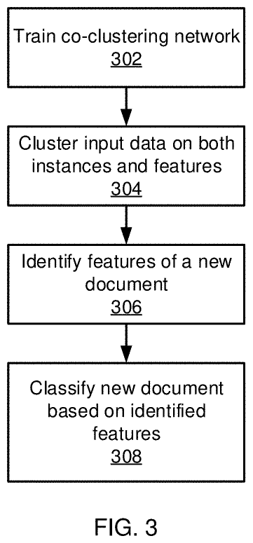

Referring now to FIG. 3, a method for co-clustering data is shown. Block 202 trains a co-clustering network in an end-to-end fashion. The network is described above, with separate branches being trained for the respective instances and features using an autoencoder 102, an inference network 104, and a GMM network 106. The two branches are then cross-correlated to in block 108 and the cross correlation loss information is used in co-clustering to generate an output. The training process uses training data that includes a set of known inputs and their corresponding known co-clustered outputs, which can be supplied by any appropriate means. The training 302 uses discrepancies between the network's generated output and the expected output to provide adjustments to the weights 204 of the network.

It is specifically contemplated that the entire co-clustering process is trained end-to-end, rather than training each segment in a piecewise fashion. This advantageously prevents the training process from stopping in local optima in the autoencoders 102, helping improve overall co-clustering performance.

Block 304 then uses the trained network to perform clustering on input data that has dependencies between its rows and columns. As noted above, block 304 reduces the dimensionality of the data and then performs inferences on the rows and the columns before identifying a mutual information loss between the rows and the columns that can be used to co-cluster them. The output can be, for example, a matrix having one or more co-clusters within it, with the co-clusters representing groupings of data that have relationships between their column and row information.

Block 306 then uses the trained co-clustering network to identify clustered features of a new document. In some embodiments, the new document can represent textual data, but it should be understood that other embodiments can include documents that represent any kind of data, such as graphical data, audio data, binary data, executable data, etc. Block 308 uses the network to identify document clusters based on how the identified features of the new document aligns with known feature clusters. Thus, in one example, the words in a text document can be mapped to word clusters for known documents. The word clusters thereby identify corresponding co-clustered document clusters, such that block 308 finds a classification for the new document.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

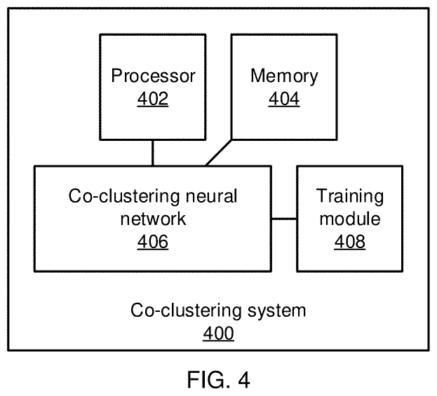

Referring now to FIG. 4, a co-clustering system 400 is shown. The system 400 includes a hardware processor 402 and memory 404. A co-clustering neural network 406 is implemented as described above, with autoencoders 102, inference networks 104, and GMM networks 106. The co-clustering neural network 406 also includes static functions, such as the cross-loss block 108 and the joint optimization performed by co-clustering 110.

A training module 408 can be implemented as software that is stored in the memory 404 and that is executed by the hardware processor. In other embodiments, the training module 408 can be implemented in one or more discrete hardware components such as, e.g., an application-specific integrated chip or a field programmable gate array. The training module 408 trains the neural network 406 in an end-to-end fashion using a provided set of training data.

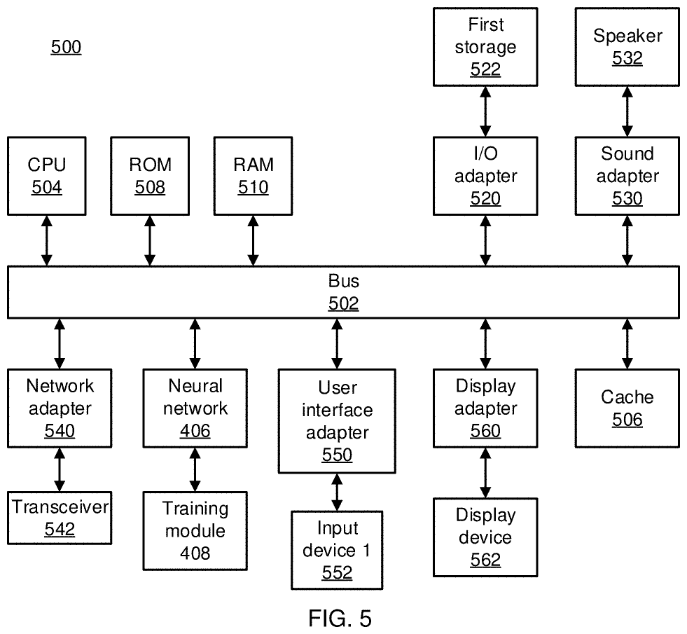

Referring now to FIG. 5, an exemplary processing system 500 is shown which may represent the co-clustering system 400. The processing system 500 includes at least one processor (CPU) 504 operatively coupled to other components via a system bus 502. A cache 506, a Read Only Memory (ROM) 508, a Random Access Memory (RAM) 510, an input/output (I/O) adapter 520, a sound adapter 530, a network adapter 540, a user interface adapter 550, and a display adapter 560, are operatively coupled to the system bus 502.

A first storage device 522 is operatively coupled to system bus 502 by the I/O adapter 520. The storage device 522 can be any of a disk storage device (e.g., a magnetic or optical disk storage device), a solid state magnetic device, and so forth. The storage device 522 can be the same type of storage device or different types of storage devices.

A speaker 532 is operatively coupled to system bus 502 by the sound adapter 530. A transceiver 542 is operatively coupled to system bus 502 by network adapter 540. A display device 562 is operatively coupled to system bus 502 by display adapter 560.

A first user input device 552 is operatively coupled to system bus 502 by user interface adapter 550. The user input device 552 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input device 522 can be the same type of user input device or different types of user input devices. The user input device 552 is used to input and output information to and from system 500.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present principles provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for co-clustering data, comprising:
reducing dimensionality for instances and features of an input dataset independently of one another;
determining a mutual information loss for the instances and the features independently of one another;
cross-correlating the instances and the features, using a processor, based on the mutual information loss, to determine a cross-correlation loss; and
determining co-clusters in the input data based on the cross-correlation loss.

2. The method of claim 1, further comprising classifying a new instance based on associated new features.

3. The method of claim 1, wherein the instances include documents and the features include words associated with respective documents.

4. The method of claim 1, wherein determining the mutual information loss includes an inference neural network step and a Gaussian mixture model step.

5. The method of claim 4, further comprising an inference neural network and a Gaussian mixture model in an end-to-end fashion.

6. The method of claim 1, wherein determining co-clusters includes optimizing an objective function that includes a respective dimension reconstruction loss term for the instances and for the features and a cross-correlation loss term that includes the determined cross-correlation loss.

7. The method of claim 6, wherein the objective function is:
$${min}_{{θ}_{r} , {θ}_{c} , {η}_{r} , {η}_{c}} J = {J}_{1} + {J}_{2} + {J}_{3}$$
where J₁ is the reconstruction loss term for the instances, J₂ is the reconstruction loss term for the features, J₃ is the cross-correlation loss term, θᵣ and θ_{c} are dimension reduction parameters for the instances and the features, respectively, and ηᵣ and η_{c} are mutual information loss parameters for the instances and the features, respectively.

8. The method of claim 6, wherein reducing the dimensionality of the instances and the features comprises applying respective autoencoders to the input data.

9. The method of claim 8, wherein each autoencoder determines a dimension reconstruction loss by reducing the dimensionality of data and then restoring the reduced dimensionality data to an original dimensionality.

10. The method of claim 1, further comprising performing text classification using the determined co-clusters.

11. A data co-clustering system, comprising:
an instance autoencoder configured to reduce a dimensionality for instances of an input dataset;
a feature autoencoder configured to reduce a dimensionality for features of an input dataset;
an instance mutual information loss branch configured to determining a mutual information loss for the instances;
a feature mutual information loss branch configured to determine a mutual information loss for the features;
a processor configured to cross-correlate the instances and the features based on the mutual information loss, to determine a cross-correlation loss and to determine co-clusters in the input data based on the cross-correlation loss.

12. The system of claim 11, wherein the processor is further configured to classify a new instance based on associated new features.

13. The system of claim 11, wherein the instances include documents and the features include words associated with respective documents.

14. The system of claim 11, wherein the input dataset comprises a matrix having columns that represent one of the features and the instances and rows that represent the other of the features and the instances.

15. The system of claim 11, wherein each mutual information loss branch determines a respective mutual information loss using an inference neural network and a Gaussian mixture model.

16. The system of claim 15, further comprising a training module configured to train the inference neural network and a Gaussian mixture model in an end-to-end fashion.

17. The system of claim 11, wherein the processor is further configured to determine co-clusters using optimizing an objective function that includes a respective dimension reconstruction loss term for the instances and for the features and a cross-correlation loss term that includes the determined cross-correlation loss.

18. The system of claim 17, wherein the objective function is:
$${min}_{{θ}_{r} , {θ}_{c} , {η}_{r} , {η}_{c}} J = {J}_{1} + {J}_{2} + {J}_{3}$$
where J₁ is the reconstruction loss term for the instances, J₂ is the reconstruction loss term for the features, J₃ is the cross-correlation loss term, θᵣ and θ_{c} are dimension reduction parameters for the instances and the features, respectively, and ηᵣ and η_{c} are mutual information loss parameters for the instances and the features, respectively.

20. The method of claim 17, wherein each autoencoder determines a dimension reconstruction loss by reducing the dimensionality of data and then restoring the reduced dimensionality data to an original dimensionality.
